(19) United States
(12) Patent Application Publication
(10) Pub. No.: US 2025/0023467 A1
(43) Pub. Date: Jan. 16, 2025

(54) POWER CONVERTER ADOPTING HYBRID MODULATION AND CONTROL CIRCUIT AND CONTROL METHOD THEREOF

(71) Applicant: Joulwatt Technology Co., Ltd., Hangzhou (CN)

(72) Inventor: Xiaoming WANG, Hangzhou (CN)

(21) Appl. No.: 18/770,762

(22) Filed: Jul. 12, 2024

(30) Foreign Application Priority Data
Jul. 14, 2023 (CN) 202310868067.6

(51) Int. Cl. H02M 3/157; H02M 3/158

(52) U.S. Cl. CPC H02M 3/157; H02M 3/158

(57) ABSTRACT

The present disclosure relates to a power converter adopting hybrid modulation and a control circuit and a control method thereof. The control circuit includes: a loop compensation unit for obtaining a compensation amount for a switching control signal according to a voltage feedback signal of an output voltage; a switching cycle calculation unit for allocating the compensation amount as a switching cycle compensation amount according to a first preset weight; an on-time calculation unit for allocating the compensation amount as an on-time compensation amount according to a second preset weight; and a hybrid modulator for generating the switching control signal according to the switching cycle compensation amount and the on-time compensation amount. The control circuit modulates the on-time and switching cycle of the switching control signal based on the preset weights, respectively, so as to improve circuit stability, improve circuit dynamic response speed and reduce electromagnetic interference.

### CROSS-REFERENCE TO RELATED APPLICATIONS

This present disclosure claims priority to a Chinese patent application No. 202310868067.6, filed on Jul. 14, 2023, published as CN117277756A on Dec. 22, 2023, and entitled “POWER CONVERTER ADOPTING HYBRID MODULATION AND CONTROL CIRCUIT AND CONTROL METHOD THEREOF”, the entire contents of which are incorporated herein by reference, including the specification, claims, drawings and abstract.

### FIELD OF TECHNOLOGY

The present disclosure relates to a technical field of power supply, and in particular, to a power converter adopting hybrid modulation and a control circuit and a control method thereof.

### BACKGROUND

In an electronic device, a power converter has been widely adopted to provide a supply voltage of an electronic component inside the electronic device. For example, the supply voltage of the electronic component is higher than a battery voltage, and the power converter is used to convert the battery voltage to the supply voltage of the electronic component, so that the electronic device could work normally.

The power converter controls an electrical energy transferred from an input terminal to an output terminal of the power converter by controlling a switching device (e.g., transistor, insulate gate bipolar transistor (IGBT), metal oxide semiconductor field effect transistor (MOSFET), etc.) to be on and off, so that an expected output voltage and/or output current is obtained. Switching states of the switching device could be controlled by various control strategies and modulation techniques, such as pulse width modulation (PWM), pulse frequency modulation (PFM), pulse position modulation (PPM), etc. Pulse width modulation (PWM) refers to a switching cycle of a switching control signal being constant, and adjusting a duty cycle of the switching control signal by controlling an on-time in the switching cycle, so as to achieve the purpose of controlling the output voltage of the power converter. Pulse frequency modulation (PFM) refers to the on-time of the switching control signal being constant, and adjusting the duty cycle of the switching control signal by controlling the switching cycle, so as to achieve the purpose of controlling the output voltage of the power converter.

In the power converter, an advantage of adopting pulse width modulation is that accurate output voltage control and voltage stabilization performance could be achieved, but there is a disadvantage of large switching loss and large electromagnetic interference. An advantage of adopting pulse frequency modulation is that the electromagnetic interference is small and the switching cycle could be changed to reduce energy loss during light loading, but there is a disadvantage of poor voltage stabilization performance. In order to balance the advantages of the two modulation modes, a hybrid modulation scheme of the two modulators has been adopted in existing power converters to achieve a selective modulation mode.

FIGS. 1 and 2 show a schematic circuit diagram and an operating waveform diagram of a power converter according to the prior art, respectively. The power converter 100 adopts a buck topology, for example, wherein transistors Q1 and Q2 are connected in series between an input terminal of the power converter 100 and ground, and an inductor L is connected between an intermediate nodes of the transistors Q1 and Q2 and an output terminal of the power converter 100. In the power converter100, the control circuit 110 includes a PWM modulator 112, a PFM modulator 113, and a multiplexer 114. In a heavy load state, the multiplexer 114 selects a switching control signal generated by the PWM modulator 112. In a light load state, the multiplexer 114 selects a switching control signal generated by the PFM modulator 113. The power converter 100 dynamically selects the modulation mode according to the load state, so as to balance the voltage stabilization performance and circuit efficiency.

However, the power converter described above is still a single modulation mode at any given moment. Further, when the power converter switches from one modulation mode to another, the switching cycle and the on-time of the switching control signal generated by the control circuit may jump, making it difficult to achieve smooth switching. Therefore, not only may the dynamic response characteristics of the circuit be degraded and the output voltage fluctuate, but also additional noise and additional power consumption may be generated, and even the switching control of the control may fail due to frequent mode switching.

Therefore, it is desirable to further improve the hybrid modulation scheme of the power converter to overcome the above technical problems existing in the prior art.

### SUMMARY OF THE DISCLOSURE

In view of above problems, an object of the present disclosure is to provide a power converter with a hybrid modulation and a control circuit and a control method thereof. In the hybrid modulation, an on-time and a switching cycle of a switching control signal are respectively modulated based on a preset weight to improve circuit stability, so as to improve the dynamic response speed of the circuit, and reduce electromagnetic interference.

According to an aspect of the present disclosure, there is provided a control circuit for a power converter. The control circuit includes a loop compensation unit, a switching cycle calculation unit, an on-time calculation unit and a hybrid modulator. The loop compensation unit is used for obtaining a compensation amount for a switching control signal according to a voltage feedback signal of an output voltage. The switching cycle calculation unit is used for allocating the compensation amount as a switching cycle compensation amount according to a first preset weight. The on-time calculation unit is used for allocating the compensation amount as an on-time compensation amount according to a second preset weight. The hybrid modulator is used for generating the switching control signal according to the switching cycle compensation amount and the on-time compensation amount.

Optionally, in continuous switching cycles, the control circuit synchronously and dynamically adjusts a switching cycle and an on-time of the switching control signal as a load state changes.

Optionally, at least one of the first preset weight and the second preset weight is greater than zero, so that according to values of the first preset weight and the second preset weight, a modulation mode of the control circuit is one of pulse width modulation mode (PWM mode), pulse frequency modulation mode (PFM mode) and hybrid modulation mode.

Optionally, a sum of the first preset weight and the second preset weight is equal to or greater than 1, so that a compensation mode of the control circuit is one of accurate compensation mode and over compensation mode.

Optionally, the switching cycle calculation unit calculates the switching cycle compensation amount based on a formula as follow:

$$Δ T s w = - K p f m * \frac{T R s {w}^{2}}{T R o n} * Δ d ,$$

wherein, Kpfm represents the first preset weight, TRon represents an initial on-time of the switching control signal, TRsw represents an initial switching cycle of the switching control signal, and Δd represents the compensation amount for the switching control signal obtained according to the voltage feedback signal.

Optionally, the on-time calculation unit calculates the on-time compensation amount based on a formula as follow:

$$Δ T o n = K p w m * T R s w * Δ d ,$$

wherein Kpwm represents the second preset weight, TRon represents an initial on-time of the switching control signal, TRsw represents an initial switching cycle of the switching control signal, and Δd represents the compensation amount for the switching control signal obtained according to the voltage feedback signal.

Optionally, the hybrid modulator performs a numerical calculation based on the switching cycle compensation amount and the on-time compensation amount, and performs a digital-to-analog conversion to generate the switching control signal.

Optionally, the hybrid modulator includes an RS flip-flop, and the hybrid modulator generates a reset signal based on the switching cycle compensation amount, generates a set signal based on the on-time compensation amount, and the RS flip-flop generates the switching control signal based on the reset signal and the set signal.

Optionally, the loop compensation unit includes: a comparison module for comparing the voltage feedback signal with a reference voltage to obtain an error signal; and a proportion integral differential module for obtaining the compensation amount for the switching control signal using a proportion integral differential (PID) algorithm according to the error signal.

Optionally, the loop compensation unit includes: an error amplifier for converting an error signal between the voltage feedback signal and a reference voltage into a differential current; a capacitor connected to an output terminal of the error amplifier, wherein the capacitor is charged with the differential current to obtain the compensation amount for the switching control signal.

According to a second aspect of the present disclosure, there is provided a power converter, including: an input terminal and an output terminal for receiving an input voltage and providing an output voltage, respectively; an inductor and a transistor coupled between the input terminal and the output terminal; and the control circuit according to any one of the above-mentioned embodiments, wherein the control circuit is configured to generate a switching control signal of the transistor, charge the inductor with the input voltage when the transistor is in on state, and discharge the inductor when the transistor is in off state, so as to generate the output voltage on the output terminal.

Optionally, the power converter includes a power converter of any one of BOOST topology, BUCK topology, BUCK-BOOST topology, FLYBACK topology.

According to a third aspect of the present disclosure, there is provided a control method for a power converter, including: obtaining a compensation amount for a switching control signal according to a voltage feedback signal of an output voltage; allocating the compensation amount as a switching cycle compensation amount according to a first preset weight; allocating the compensation amount to an on-time compensation amount according to a second preset weight; and generating a switching control signal according to the switching cycle compensation amount and the on-time compensation amount.

Optionally, in continuous switching cycles, the control method synchronously and dynamically adjusts a switching cycle and an on-time of the switching control signal as a load state changes.

Optionally, at least one of the first preset weight and the second preset weight is greater than zero, so that according to values of the first preset weight and the second preset weight, a modulation mode of the control circuit is one of PWM mode, PFM mode and hybrid modulation mode.

Optionally, a sum of the first preset weight and the second preset weight is equal to or greater than 1, so that a compensation mode of the control circuit is one of accurate compensation mode and over compensation mode.

Optionally, the switching cycle compensation amount is calculated based on a formula as follow:

$$Δ T s w = - K p f m * \frac{T R s {w}^{2}}{T R o n} * Δ d ,$$

wherein, Kpfm represents the first preset weight, TRon represents an initial on-time of the switching control signal, TRsw represents an initial switching cycle of the switching control signal, and Δd represents the compensation amount for the switching control signal obtained according to the voltage feedback signal.

Optionally, the on-time compensation amount is calculated based on a formula as follow:

$$Δ T o n = K p w m * T R s w * Δ d ,$$

wherein Kpwm represents the second preset weight, TRon represents an initial on-time of the switching control signal, TRsw represents an initial switching cycle of the switching control signal, and Δd represents the compensation amount for the switching control signal obtained according to the voltage feedback signal.

According to the power converter of the embodiments of the present disclosure, the control circuit could operate in any one of PWM mode, PFM mode and hybrid modulation mode by setting the preset weight Kpfm of the switching cycle and the preset weight Kpwm of the on-time. The control circuit could operate in PFM mode when the preset weight Kpfm is greater than 0 and the preset weight Kpwm is equal to 0. The control circuit could operate in PWM mode when the preset weight Kpfm is equal to 0 and the preset weight Kpwm is greater than 0. Hybrid modulation mode could be operated when the preset weight Kpfm and the preset weight Kpwm are both greater than 0. Therefore, the control circuit is a combined design of multi-mode modulation, in which multiple modulation modes share a loop compensation unit and a calculation unit, which can simplify a loop circuit design and reduce a cost of the control circuit.

According to the power converter of the embodiment of the present disclosure, in the hybrid modulation mode, the control circuit dynamically adjusts the on-time and the switching cycle of the switching control signal according to the voltage feedback signal. Since the duty cycle of the switching control signal is related to the on-time and the switching cycle, the dynamic adjustment of the on-time and the switching cycle could improve a response speed of the circuit and help reduce a voltage ripple. Further, by dynamically adjusting the switching cycle, the electromagnetic interference generated by the switching control signal could be reduced compared with a solution using a constant frequency switching control signal.

In an optional embodiment, the preset weight Kpfm of the switching cycle and the preset weight Kpwm of the on-time satisfy a condition that (Kpfm+Kpwm)=1. In this case, a total compensation amount of the on-time and the switching cycle of the switching control signal is equal to an expected compensation amount of the ripple of the output voltage Vo, so as to obtain an optimized circuit stability.

In an alternative embodiment, the preset weight Kpfm of the switching cycle and the preset weight Kpwm of the on-time satisfy a condition that (Kpfm+Kpwm)>1. In this case, the total compensation amount of the on-time and the switching cycle of the switching control signal is equal to an expected compensation amount of a ripple of the output voltage Vo, so as to perform overcompensation to improve a dynamic response speed of the circuit.

### BRIEF DESCRIPTION OF THE DRAWINGS

FIG. 1 shows a schematic circuit diagram of a power converter according to a prior art.

FIG. 2 shows an operating waveform diagram of a transistor in the power converter shown in FIG. 1.

FIG. 3 shows a schematic circuit diagram of a power converter according to an embodiment of the present disclosure.

FIG. 4 shows a schematic circuit diagram of a first embodiment of a loop compensation unit in the power converter shown in FIG. 3.

FIG. 5 shows a schematic circuit diagram of a second embodiment of a loop compensation unit in the power converter shown in FIG. 3.

FIG. 6 shows an operating waveform diagram of a transistor in the power converter shown in FIG. 3.

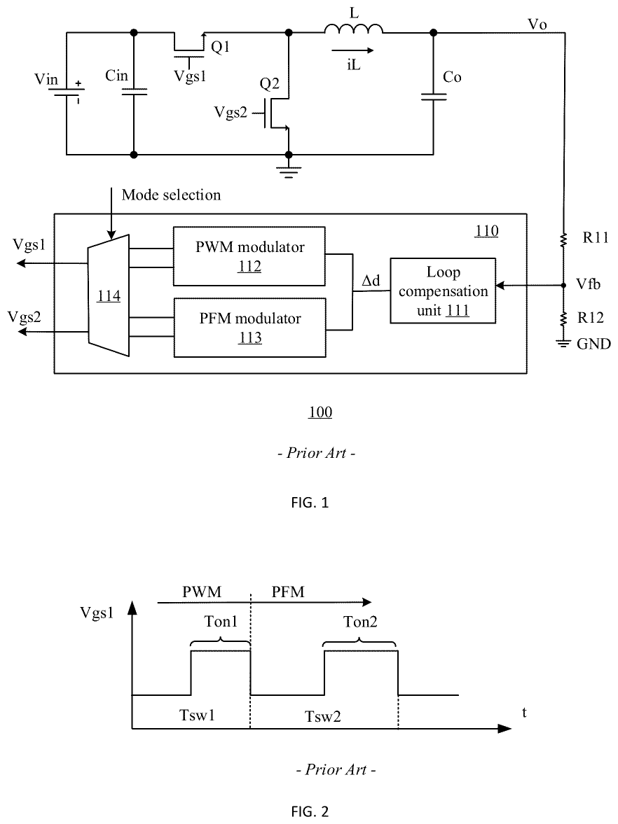

### DETAILED DESCRIPTION OF THE DISCLOSURE

Preferred embodiments of the present disclosure are described in detail below in conjunction with accompanying drawings, but the present disclosure is not limited to these embodiments. The present disclosure encompasses any substitutions, modifications, equivalents, and solutions made in the spirit and scope of the present disclosure.

In order to give the public a thorough understanding of the present disclosure, specific details are described in the following preferred embodiments of the present disclosure. However, the present disclosure can be fully understood without a description of these details for those skilled in the art.

The present disclosure is described in more detail by way of example in the following paragraphs with reference to the accompanying drawings. It should be noted that the accompanying drawings are in a relatively simplified form and not drawn to accurate scale, and are only used to conveniently and clearly illustrate the purpose of the embodiments of the present disclosure.

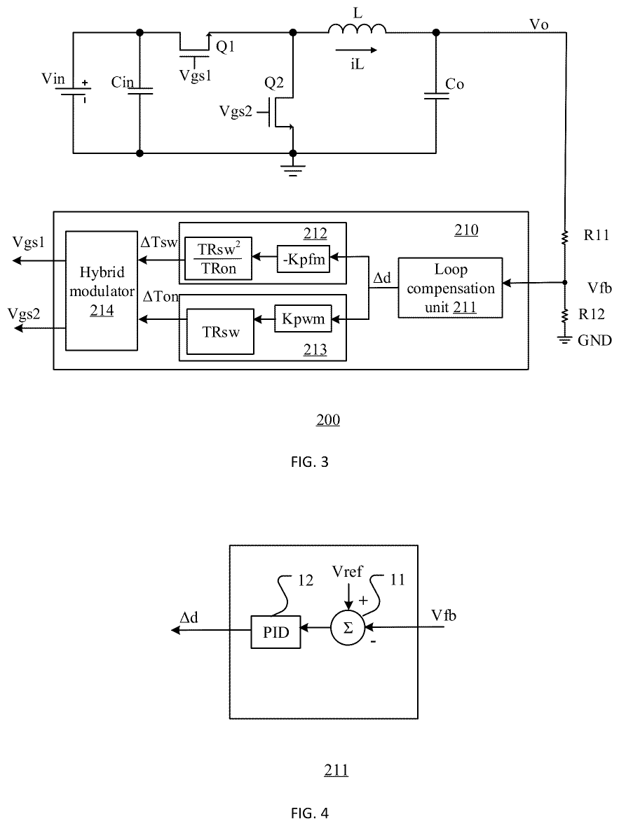

FIG. 3 shows a schematic circuit diagram of a power converter according to an embodiment of the present disclosure. In this embodiment, illustrated with a power converter 200 of a buck topology.

The power converter 200 includes, for example, transistors Q1 and Q2, an inductor L, and a control circuit 210. The transistors Q1 and Q2 are connected in series between an input terminal of the power converter 200 and ground, and the inductor L is connected between an intermediate node of the transistors Q1 and Q2 and an output terminal of the power converter 200. An input capacitor Cin is connected between the input terminal and the ground, and an output capacitor Co is connected between the output terminal and the ground for obtaining smooth waveforms of an input voltage Vin and an output voltage Vo.

The power converter 200 further includes resistors R11 and R12 connected in series between the output terminal and the ground. A voltage feedback signal Vfb of the output voltage Vo is obtained at an intermediate node of the resistors R11 and R12. Alternatively, the power converter 200 may further include a current sense device (e.g., a sampling resistor) connected between the transistor Q2 and the ground for obtaining a current sense signal Vsen of an inductor current iL when the transistor Q2 is in on state.

Control ends of the transistor Q1 and Q2 receive switching control signals Vgs1 and Vgs2, respectively. The switching control signals Vgs1 and Vgs2 are non-overlapping signals. Therefore, during a switching cycle, the on-time period of the transistors Q1 and the on-time period of the transistor Q2 are different from each other. When the transistor Q1 is on, the transistor Q2 is off. The input terminal of the power converter 200 receives the input voltage Vin, and charges the inductor L with the input voltage Vin when the input voltage Vin is used to supply power to the output terminal. The inductor current iL flows through the transistor Q1 and the inductor L in turn. When the transistor Q1 is off, the transistor Q2 is on. The inductor L discharges to the output terminal through the transistor Q2, so as to generate the output voltage Vo. In continuous switching cycles, the output capacitor Co filters the output voltage Vo to obtain a smooth voltage waveform.

The control circuit 210 includes a loop compensation unit 211, a switching cycle calculation unit 212, an on-time calculation unit 213, and a hybrid modulator 214.

An input terminal of the loop compensation unit 211 receives the voltage feedback signal Vfb, and generates a compensation amount Δd for the switching control signal according to the voltage feedback signal Vfb. The switching cycle calculation unit 212 and the on-time calculation unit 213 have preset weight Kpfm and preset weight Kpwm, respectively.

Further, the switching cycle calculation unit 212 obtains a switching cycle compensation amount ΔTsw of the switching cycle according to the preset weight, and the on-time calculation unit 213 obtains an on-time compensation amount ΔTon of the on-time according to the preset weight.

Further, the hybrid modulator 214 superimposes an initial switching cycle TRsw with the switching cycle compensation amount ΔTsw, and superimposes an initial on-time TRon with the on-time compensation amount ΔTon, so as to modulate the on-times and the switching cycles of the switching control signals Vgs1 and Vgs2.

In this embodiment, for example, the hybrid modulator 214 performs a numerical calculation of a numerical value of the initial switching cycle TRsw and a numerical value of the switching cycle compensation amount ΔTsw based on the numerical value of the switching cycle compensation amount ΔTsw to obtain a numerical value of a switching cycle Tsw, and performs a numerical calculation of a numerical value of the initial on-time TRon and a numerical value of the on-time compensation amount ΔTon based on the numerical value of the on-time compensation amount ΔTon to obtain a numerical value of an on-time Ton, and then performs a digital-to-analog conversion to generate the switching control signal Vgs1.

In an alternative embodiment, for example, the hybrid modulator 214 includes a superimposing circuit and an RS flip-flop. The superimposing circuit superimposes an analog value of the initial switching cycle TRsw and an analog value of the switching cycle compensation amount ΔTsw to obtain a reset signal related to the switching cycle Tsw, and superimposes an analog value of the initial on-time TRon and an analog value of the on-time compensation amount ΔTon to obtain a set signal related to the on-time Ton. The RS flip-flop generates the switching control signal Vgs1 according to the reset signal and the set signal.

Specifically, a hybrid modulation control principle of the switching power converter 200 is further illustrated with the switching control signal Vgs1 as an example.

At any moment, a duty cycle D of the switching control signal Vgs1 is calculated by formula (1):

$$D = \frac{T o n}{T s w} \qquad ( 1 )$$

wherein, Ton represents the on-time of the switching control signal, and Tsw represents the switching cycle of the switching control signal.

A change ΔD of the duty cycle D of the switching control signal Vgs1 obtained according to the formula (1) is calculated by formula (2):

$$Δ D = - \frac{T R o n}{T R s {w}^{2}} * Δ T s w + \frac{1}{T R s w} * Δ T o n \qquad ( 2 )$$

wherein, TRon represents an initial on-time of the switching control signal, TRsw represents an initial switching cycle of the switching control signal, ΔTon represents a change of the on-time of the switching control signal, ΔTsw represents a change of the switching cycle of the switching control signal.

In the control circuit 210 of the power converter 200, the change ΔD of the duty cycle D of the switching control signal Vgs1 is compensated, and the control circuit 210 performs compensation opposite to the change ΔD based on the voltage feedback signal, so that a stable output voltage could be provided. The control circuit 210 compensates the duty cycle D of the switching control signal Vgs1 by a compensation amount Δd, which has an absolute value equal to an absolute value of the change ΔD and has a sign opposite to a sign of the change ΔD.

Accordingly, the compensation of the duty cycle D of the switching control signal Vgs1 by the control circuit 210 could be achieved by the switching cycle calculation unit 212 and the on-time calculation unit 213, as expressed in formula (3) and formula (4),

$$Δ T s w = - K p f m * \frac{T R s {w}^{2}}{T R o n} * Δd \qquad ( 3 )$$

$$Δ Ton = K p w m * T R s w * Δ d \qquad ( 4 )$$

wherein, Kpfm represents the preset weight of the switching cycle, Kpwm represents the preset weight of the on-time, TRon represents the initial on-time of the switching control signal, TRsw represents the initial switching cycle of the switching control signal, ΔTon represents a change/compensation amount of the on-time of the switching control signal, ΔTsw represents a change/compensation amount of the switching cycle of the switching control signal.

According to the above formulas (2) to (4), based on the preset weight Kpfm and preset weight Kpwm, the on-time and the switching cycle of the switching control signal Vgs1 are respectively modulated, and a ripple of the output voltage Vo could be accurately compensated according to the voltage feedback signal Vfb, so as to obtain a stable output voltage Vo.

According to the power converter of the embodiments of the present disclosure, the control circuit could operate in any modulation mode of PWM mode, PFM mode and hybrid modulation mode by setting the preset weight Kpfm of the switching cycle and the preset weight Kpwm of the on-time. The control circuit could operate in PFM mode when the preset weight Kpfm is greater than 0 and Kpwm is 0. The control circuit could operate in PWM mode when the preset weight Kpfm is equal to 0 and the preset weight Kpwm is greater than 0. Hybrid modulation mode could be operated when the preset weight Kpfm and the preset weight Kpwm are both greater than 0. Therefore, the control circuit is a combined design of multi-mode modulation, in which multiple modulation modes share a loop compensation unit and a calculation unit, which can simplify a circuit design and reduce a cost of the control circuit.

According to the power converter of the embodiment of the present disclosure, in the hybrid modulation mode, the control circuit dynamically adjusts the on-time and the switching cycle of the switching control signal according to the voltage feedback signal. Since the duty cycle of the switching control signal is related to the on-time and the switching cycle, the dynamic adjustment of the on-time and the switching cycle could improve a response speed of the circuit and help reduce a voltage ripple. Further, by dynamically adjusting the switching cycle, the electromagnetic interference generated by the switching control signal could be reduced compared with a solution using a constant frequency switching control signal.

In an optional embodiment, the preset weight Kpfm of the switching cycle and the preset weight Kpwm of the on-time satisfy a condition that (Kpfm+Kpwm)=1. In this case, a total compensation amount of the on-time and the switching cycle of the switching control signal is equal to an expected compensation amount of a ripple of the output voltage Vo, so as to perform accurate compensation to obtain an optimized circuit stability.

In alternative embodiments, the preset weight Kpfm of the switching cycle and the preset weight Kpwm of the on-time satisfy a condition that: (Kpfm+Kpwm)>1. In this case, the total compensation amount of the on-time and the switching cycle of the switching control signal is equal to the expected compensation amount of the ripple of the output voltage Vo, so as to perform overcompensation to improve a dynamic response speed of the circuit.

FIG. 4 shows a schematic circuit diagram of a first embodiment of a loop compensation unit in the power converter shown in FIG. 3.

In this example, the loop compensation unit 211 in the control circuit 210 includes, for example, a comparison module 11 and a proportional integral differential (PID) controller 12. The comparison module 11 compares the voltage feedback signal Vfb with a reference voltage Vref to obtain an error signal. The PID controller 12 obtains, for example, a digital value of the error signal and obtains the compensation amount Δd based on a PID control algorithm.

Further, the control circuit 210 allocates the compensation amount Δd into a switching cycle compensation amount ΔTsw and an on-time compensation amount ΔTon based on the preset weight Kpfm and the preset weight Kpwm, respectively, and respectively modulates the on-time and the switching cycle of the switching control signal to achieve hybrid modulation.

FIG. 5 shows a schematic circuit diagram of a second embodiment of a loop compensation unit in the power converter shown in FIG. 3.

In this embodiment, the loop compensation unit 311 in the control circuit 210 includes, for example, an error amplifier U1, a comparator U2, a resistor R103, and capacitors C101 and C102. A non-inverting input terminal and an inverting input terminal of the error amplifier U1 receive the voltage feedback signal Vfb and the reference voltage Vref, respectively. The error amplifier U1 is, for example, a transconductance amplifier for converting a differential voltage between the voltage feedback signal Vfb and the reference voltage Vref into an output current. The resistor R103 and the capacitor C101 are connected in series between an output terminal of the error amplifier U1 and the ground, and the output current generated by the error amplifier U1 charges the capacitor C101 through the resistor R103, thereby converting the output current generated by the error amplifier U1 into the switching control signal compensation amount Δd. The capacitor C102 is connected between the output terminal of the error amplifier U1 and the ground for obtaining a smooth voltage waveform of the switching control signal compensation amount Δd.

Further, the control circuit 210 allocates the compensation amount Δd into the switching cycle compensation amount ΔTsw and the on-time compensation amount ΔTon based on the preset weight Kpfm and the preset weight Kpwm, respectively, and respectively modulates the on-time and the switching cycle of the switching control signal to achieve hybrid modulation.

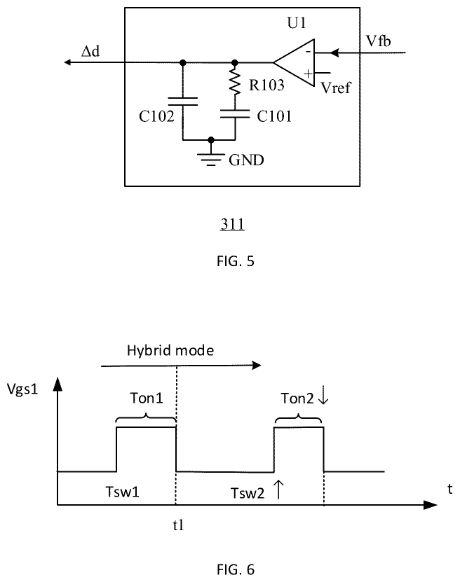

FIG. 6 shows an operating waveform diagram of a transistor in the power converter shown in FIG. 3.

In the power converter 200, the switching control signal Vgs1 generated by the control circuit 210 is used to control the transistor Q1 to be turned on and off.

The control circuit 210 could operate in any modulation mode of PWM mode, PFM mode, and hybrid modulation mode by setting the preset weight Kpfm of the switching cycle and the preset weight Kpwm of the on-time. Hybrid modulation could be operated when the preset weight Kpfm and the preset weight Kpwm are both greater than 0.

Referring to FIG. 6, a load state of the power converter 200 changes from heavy load to light load over two continues switching cycles. In two continues switching cycles, as the load becomes lighter, at time t1, the switching cycle increases from Tsw1 to Tsw2, and the on-time decreases from Ton1 to Ton2.

In the hybrid modulation mode, the control circuit of the control circuit 200 synchronously and dynamically adjusts two parameters, that is, the on-time and the switching cycle, related to the duty cycle of the switching control signal. Dynamic adjustment of the on-time and switching cycle could improve a circuit response speed and help reduce an output voltage ripple compared to a solution using a single parameter adjustment under the PWM mode and the PFM mode.

In the hybrid modulation mode, the modulation mode of the power converter 200 is always maintained in the same modulation mode. The hybrid modulation mode does not need to be switched from one modulation mode to another, so that the switching cycle and on-time of the switching control signal Vgs1 could be continuously and smoothly changed, as so to improve the dynamic response characteristic of the circuit and reduce the output voltage ripple.

In the embodiments described in detail above, the power converter of the buck topology is taken as an example to illustrate the operating principle of the present disclosure. However, it should be understood that the present disclosure is not limited thereto.

Based on similar operating principles, the present disclosure could be applied to power converters of any topology type. The power converter includes a power converter of any of a boost topology, a buck topology, a buck-boost topology, and a flyback topology.

The above-mentioned embodiments do not limit the scope of protection of the technical solution. Any modifications, equivalent substitutions, and improvements made within the spirit and principles of the embodiments mentioned above shall be included within the scope of protection of the present disclosure.

What is claimed is:

1. A control circuit for a power converter, wherein the control circuit comprises:
a loop compensation unit for obtaining a compensation amount for a switching control signal according to a voltage feedback signal of an output voltage;
a switching cycle calculation unit for allocating the compensation amount as a switching cycle compensation amount according to a first preset weight;
an on-time calculation unit for allocating the compensation amount as an on-time compensation amount according to a second preset weight; and
a hybrid modulator for generating the switching control signal according to the switching cycle compensation amount and the on-time compensation amount.

2. The control circuit according to claim 1, wherein, in continuous switching cycles, the control circuit synchronously and dynamically adjusts a switching cycle and an on-time of the switching control signal as a load state changes.

3. The control circuit according to claim 1, wherein at least one of the first preset weight and the second preset weight is greater than zero, according to values of the first preset weight and the second preset weight, a modulation mode of the control circuit is one of PWM mode, PFM mode and hybrid modulation mode.

4. The control circuit according to claim 1, wherein a sum of the first preset weight and the second preset weight is equal to or greater than 1, so that a compensation mode of the control circuit is one of accurate compensation mode and over compensation mode.

5. The control circuit according to claim 1, wherein the switching cycle calculation unit calculates the switching cycle compensation amount based on a formula as follow:
$$Δ T s w = - K p f m * \frac{T R s {w}^{2}}{T R o n} * Δ d ,$$
wherein, Kpfm represents the first preset weight, TRon represents an initial on-time of the switching control signal, TRsw represents an initial switching cycle of the switching control signal, and Δd represents the compensation amount for the switching control signal obtained according to the voltage feedback signal.

6. The control circuit according to claim 1, wherein the on-time calculation unit calculates the on-time compensation amount based on a formula as follow:
$$Δ T o n = K p w m * T R s w * Δ d ,$$
wherein Kpwm represents the second preset weight, TRon represents an initial on-time of the switching control signal, TRsw represents an initial switching cycle of the switching control signal, and Δd represents the compensation amount for the switching control signal obtained according to the voltage feedback signal.

7. The control circuit according to claim 1, wherein the hybrid modulator performs a numerical calculation based on the switching cycle compensation amount and the on-time compensation amount, and performs a digital-to-analog conversion to generate the switching control signal.

8. The control circuit according to claim 1, wherein the hybrid modulator comprises an RS flip-flop, and the hybrid modulator generates a reset signal based on the switching cycle compensation amount, generates a set signal based on the on-time compensation amount, and the RS flip-flop generates the switching control signal based on the reset signal and the set signal.

9. The control circuit according to claim 1, wherein the loop compensation unit comprises:
a comparison module for comparing the voltage feedback signal with a reference voltage to obtain an error signal; and
a proportion integral differential module for obtaining the compensation amount for the switching control signal using a proportion integral differential (PID) algorithm according to the error signal.

10. The control circuit according to claim 1, wherein the loop compensation unit comprises:
an error amplifier for converting an error signal between the voltage feedback signal and a reference voltage into a differential current;
a capacitor connected to an output terminal of the error amplifier, wherein the capacitor is charged with the differential current to obtain the compensation amount for the switching control signal.

11. A power converter, comprising:
an input terminal and an output terminal for receiving an input voltage and providing an output voltage, respectively;
an inductor and a transistor coupled between the input terminal and the output terminal; and
the control circuit according to claim 1,
wherein the control circuit is configured to generate a switching control signal of the transistor, charge the inductor with the input voltage when the transistor is in on state, and discharge the inductor when the transistor is in off state, so as to generate the output voltage on the output terminal.

12. A control method for a power converter, comprising:
obtaining a compensation amount for a switching control signal according to a voltage feedback signal of an output voltage;
allocating the compensation amount as a switching cycle compensation amount according to a first preset weight;
allocating the compensation amount to an on-time compensation amount according to a second preset weight; and
generating a switching control signal according to the switching cycle compensation amount and the on-time compensation amount.

13. The control method according to claim 12, wherein, in continuous switching cycles, the control method synchronously and dynamically adjusts a switching cycle and an on-time of the switching control signal as a load state changes.

14. The control method according to claim 12, wherein at least one of the first preset weight and the second preset weight is greater than zero, according to values of the first preset weight and the second preset weight, a modulation mode of the control circuit is one of PWM mode, PFM mode and hybrid modulation mode.

15. The control method according to claim 12, wherein a sum of the first preset weight and the second preset weight is equal to or greater than 1, so that a compensation mode of the control circuit is one of accurate compensation mode and over compensation mode.

16. The control method according to claim 12, wherein the switching cycle compensation amount is calculated based on a formula as follow:
$$Δ T s w = - K p f m * \frac{T R s {w}^{2}}{T R o n} * Δ d ,$$
wherein, Kpfm represents the first preset weight, TRon represents an initial on-time of the switching control signal, TRsw represents an initial switching cycle of the switching control signal, and Δd represents the compensation amount for the switching control signal obtained according to the voltage feedback signal.

17. The control method according to claim 12, wherein the on-time compensation amount is calculated based on a formula as follow:
$$Δ T o n = K p w m * T R s w * Δ d ,$$
wherein Kpwm represents the second preset weight, TRon represents an initial on-time of the switching control signal, TRsw represents an initial switching cycle of the switching control signal, and Δd represents the compensation amount for the switching control signal obtained according to the voltage feedback signal.
